(19) United States
(12) Patent Application Publication
(10) Pub. No.: US 2026/0016339 A1
(43) Pub. Date: Jan. 15, 2026

(54) ABNORMAL TEMPERATURE DETECTION SYSTEM FOR BATTERY CELL

(71) Applicant: LS ELECTRIC CO., LTD., Anyang-si, Gyeonggi-do (KR)

(72) Inventor: Hyung Suk CHOI, Anyang-si, Gyeonggi-do (KR)

(21) Appl. No.: 18/993,826

(22) PCT Filed: Jul. 18, 2023
(86) PCT No.: PCT/KR2023/010300

§ 371 Date: Jan. 13, 2025

(30) Foreign Application Priority Data
Sep. 14, 2022 (KR) 10-2022-0115351

(51) Int. Cl. G01J 5/0818; H01M 10/42

(52) U.S. Cl. CPC G01J 5/0818; H01M 10/4285

(57) ABSTRACT

Disclosed is an abnormal temperature detection system in which the amount of temperature information processing for an entire battery cell can be reduced and stability can be improved, the system comprising: a plurality of light guide plates which overlap at least a partial area of one side of a battery cell in one direction, are struck by electromagnetic waves radiated from the battery cell, and change the path of the electromagnetic waves; an image sensor which overlaps at least a partial area of each of the plurality of light guide plates in the one direction, detects the electromagnetic waves reflected from the light guide plates, and outputs temperature spectrum information for the one side of the battery cell on the basis of the detected electromagnetic waves; and a calculation unit which determines that an abnormal temperature has been detected in the battery cell if the temperature of the one side of the battery cell is outside a preset temperature range.

### CROSS-REFERENCE TO RELATED APPLICATIONS

The present application is a National Stage of International Application No. PCT/KR2023/010300, filed on Jul. 18, 2023, which claims priority to Korean Application No. 10-2022-0115351, filed Sep. 14, 2022, the entire contents of each hereby incorporated by reference.

### FIELD

The present disclosure relates to an abnormal temperature detection system for a battery cell and, more particularly, to an abnormal temperature detection system capable of further reducing temperature information throughput for the entire battery cell and further improving stability.

### BACKGROUND

Batteries for electric vehicles are generally formed in a structure in which a plurality of battery cells are arranged. In order to prevent fire of the battery and ensure the stability of the electric vehicle, it is necessary to monitor the temperatures of the plurality of battery cells and detect abnormal temperatures when abnormal temperatures occur.

To this end, a light guide plate and a light-receiving sensor are provided on one side of the battery cell to receive electromagnetic waves emitted from the battery cell and measure the temperature based on this. However, this type of temperature measuring device is composed of a plurality of light guide plates so as not to overlap with high-temperature sections such as connectors provided in the battery cell.

In a general multi-light guide plate structure, an independent image sensor is combined for each light guide plate, which increases the throughput of temperature information for the entire battery cell and is likely to cause errors in temperature measurement results.

Therefore, the development of a temperature detection system that can further reduce the temperature information throughput for the entire battery cell and improve stability may be considered.

Korean Patent Laid-Open Publication No. 10-2021-0052009 discloses a diagnosis apparatus and a diagnosis method for a battery temperature sensor. Specifically, disclosed are an apparatus and method for diagnosing a failure of each of a plurality of battery temperature sensors divided and disposed in a plurality of areas in a battery pack.

However, it is assumed that a plurality of such battery temperature sensors of this type are provided. Therefore, the temperature information throughput for the entire battery is increased, and there is a high possibility of an error in the processing result.

Korean Patent Laid-Open Publication No. 10-2022-0073561 discloses a temperature sensor array and a battery temperature measuring device including the same. Specifically, a temperature sensor array that individually measures the temperature of two or more different points and a battery temperature measuring device including the same are disclosed.

However, this type of battery temperature measuring device measures the temperature of each point individually. That is, a plurality of sensors are required. Therefore, there is an instability problem due to an increase in overall temperature information throughput. Furthermore, a solution to this is not disclosed in detail.
Korean Patent Laid-Open Publication No. 10-2021-0052009 (2021. 05. 10.)
Korean Patent Laid-Open Publication No. 10-2022-0073561 (2022. 06. 03.)

### SUMMARY

The present disclosure is directed to providing an abnormal temperature detection system for a battery cell, capable of further improving the stability of the operation of the entire battery cell.

The present disclosure is also directed to providing an abnormal temperature detection system for a battery cell, which can be more easily applied to a plurality of light guide plates formed in various arrangements.

The present disclosure is also directed to providing an abnormal temperature detection system for a battery cell, capable of further reducing manufacturing costs and processes.

The technical problems to be solved in the present disclosure are not limited to the technical problems mentioned above and other technical problems not mentioned will be clearly understood by those of ordinary skill in the art from the following description.

In order to achieve the above objects, an abnormal temperature detection system according to an exemplary embodiment of the present disclosure includes a plurality of light guide plates which overlap at least a partial region of one surface of a battery cell in one direction, are struck by electromagnetic waves radiated from the battery cell, and change the path of the electromagnetic waves; an image sensor which overlaps at least a partial region of each of the plurality of light guide plates in the one direction, detects the electromagnetic waves reflected from the light guide plates, and outputs temperature spectrum information for the one surface of the battery cell on the basis of the detected electromagnetic waves; and a calculation unit which determines that an abnormal temperature has been detected in the battery cell if the temperature of the one surface of the battery cell is outside a preset temperature range.

In addition, the electromagnetic waves may be infrared.

In addition, the plurality of light guide plates may be arranged side by side in a different direction crossing the one direction.

In addition, a withdrawal portion whose one end overlaps the image sensor in the one direction may be formed on one side of at least one of the plurality of light guide plates.

In addition, a coating layer made of a material that shields electromagnetic waves may be formed on the outer circumferential surface of the withdrawal portion.

In addition, the plurality of light guide plates may be arranged in a matrix structure with a plurality of rows arranged side by side in the different direction.

In addition, the plurality of light guide plates may be arranged side by side in the one direction.

In addition, each of the plurality of light guide plates may be disposed so as not to overlap a connector provided in the battery cell in the one direction.

In addition, when an abnormal temperature is detected in the battery cell, the calculation unit may estimate a location of the occurrence of the abnormal temperature based on the temperature spectrum information.

In addition, as another embodiment of the abnormal temperature detection system, the present disclosure provides an abnormal temperature detection system, including a plurality of light guide plates which overlap at least a partial region of one surface of a battery cell in one direction, are struck by electromagnetic waves radiated from the battery cell, and change the path of the electromagnetic waves; an image sensor which overlaps at least a partial region of each of the plurality of light guide plates in a direction crossing the one direction, detects the electromagnetic waves reflected from the light guide plates, and outputs temperature spectrum information for the one surface of the battery cell on the basis of the detected electromagnetic waves; and a calculation unit which determines that an abnormal temperature has been detected in the battery cell if the temperature of the one surface of the battery cell is outside a preset temperature range, wherein the plurality of light guide plates are arranged side by side in the one direction.

In addition, the electromagnetic waves may be infrared.

In addition, two light guide plates adjacent to each other of the plurality of light guide plates may be spaced apart from each other by placing a filler therebetween.

In addition, the plurality of light guide plates may overlap a plurality of said battery cells in the one direction, and any one of the plurality of battery cells may be disposed between said two adjacent light guide plates.

In addition, each of the plurality of light guide plates may be disposed so as not to overlap a connector provided in the battery cell in the one direction.

In addition, when an abnormal temperature is detected in the battery cell, the calculation unit may estimate a location of the occurrence of the abnormal temperature based on the temperature spectrum information.

Among the various effects of the present disclosure, the effects that can be obtained through the above-described solution are as follows.

First, the abnormal temperature detection system according to an exemplary embodiment of the present disclosure includes a plurality of light guide plates, an image sensor, and a calculation unit. Each of the plurality of light guide plates overlaps at least a portion of the battery cell in one direction. The image sensor detects the electromagnetic waves reflected from the light guide plates, and outputs temperature spectrum information of the battery cell on the basis of the detected electromagnetic waves. In this case, the image sensor overlaps the plurality of light guide plates in one direction, respectively. The calculation unit determines whether the abnormal temperature of the battery cell occurs based on the output result.

Therefore, one image sensor may receive electromagnetic waves reflected from the plurality of light guide plates. Accordingly, the temperature information throughput for the plurality of light guide plates can be further reduced, and the possibility of an error in the measurement result can also be reduced. As a result, the stability of the operation of the entire battery cell can be further improved.

In addition, the image sensor can be disposed in all directions, up, down, left, right, front, and rear, with respect to a plurality of light guide plates depending on the situation.

Therefore, the image sensor can more easily receive electromagnetic waves reflected from a plurality of light guide plates formed in various arrangements. Therefore, the applicability and utilization of the abnormal temperature detection system can be further improved.

In addition, the image sensor can detect the abnormal temperature of the battery cell even with an area smaller than the area of the entire light guide plate, and just one can detect electromagnetic waves reflected from a plurality of light guide plates.

Therefore, the number of image sensors can be further reduced, and the overall structure can be further simplified. Furthermore, manufacturing costs and processes can be further reduced.

The effects of the present disclosure are not limited to those mentioned above, and other effects not mentioned will be clearly understood by those of ordinary skill in the art from the following description.

### BRIEF DESCRIPTION OF THE DRAWINGS

FIG. 1 is a schematic diagram illustrating an abnormal temperature detection system according to an exemplary embodiment of the present disclosure.

FIG. 2 is a side cross-sectional view illustrating a temperature measurement unit provided in the abnormal temperature detection system of FIG. 1.

FIG. 3 is an exploded perspective view illustrating the temperature measurement unit of FIG. 2.

FIG. 4 is a side cross-sectional view illustrating a path of electromagnetic waves incident on the temperature measurement unit of FIG. 2.

FIG. 5 is a conceptual diagram illustrating an image sensor provided in the abnormal temperature detection system of FIG. 1.

FIG. 6 is a front cross-sectional view illustrating the image sensor of FIG. 5.

FIGS. 7 to 8 are conceptual diagrams illustrating an image sensor according to an exemplary embodiment different from that of FIG. 5.

FIG. 9 is a conceptual diagram illustrating a temperature distribution of a light guide plate coupled to the image sensor of FIG. 5 and a temperature spectrum output from the image sensor.

FIGS. 10 and 11 are conceptual diagrams illustrating an image sensor provided in an abnormal temperature detection system according to another exemplary embodiment of the present disclosure.

FIG. 12 is a conceptual diagram illustrating a temperature distribution of a light guide plate coupled to the image sensor of FIG. 10 and a temperature spectrum output from the image sensor.

### DETAILED DESCRIPTION

Hereinafter, an abnormal temperature detection system 1 according to an exemplary embodiment of the present disclosure will be described in more detail with reference to the drawings.

In the following description, in order to clarify the features of the present disclosure, descriptions of some components may be omitted.

In this specification, even in different embodiments, the same reference numerals will designate the same elements, and a redundant description thereof will be omitted.

The accompanying drawings are only for easy understanding of the embodiments disclosed herein, and the technical ideas disclosed herein are not limited by the accompanying drawings.

Expressions in the singular include plural expressions unless the context clearly indicates otherwise.

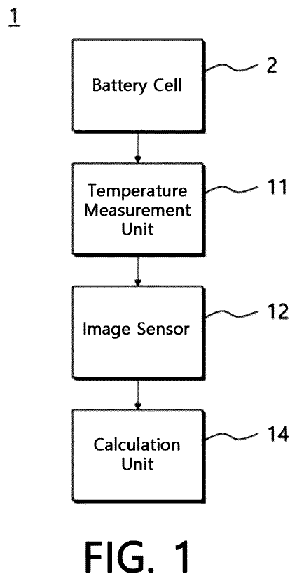

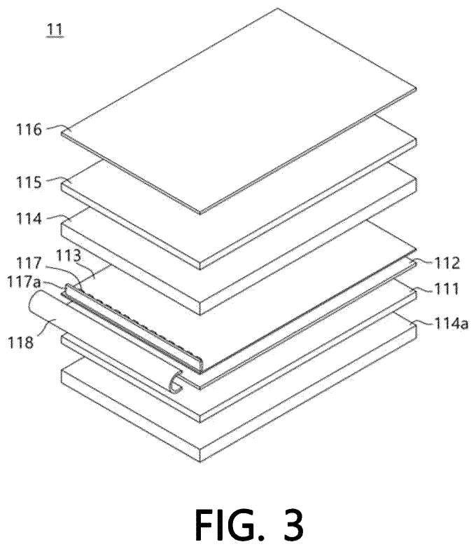

Hereinafter, an abnormal temperature detection system 1 according to an exemplary embodiment of the present disclosure will be described with reference to FIGS. 1 to 9.

The abnormal temperature detection system 1 according to an exemplary embodiment of the present disclosure is combined with a battery cell 2 to determine whether an abnormal temperature occurs in the battery cell 2.

In an embodiment, the abnormal temperature detection system 1 may be combined with a battery cell 2 for an electric vehicle. In another embodiment, the abnormal temperature detection system 1 may be combined with a lithium ion battery capable of charging and discharging electric energy.

In the illustrated embodiment, the abnormal temperature detection system 1 includes a temperature measurement unit 11, an image sensor 12, and a calculation unit 14.

The temperature measurement unit 11 overlaps at least a partial region of one surface of a battery cell 2 in one direction to measure the temperature of the battery cell 2. In an embodiment, the temperature measurement unit 11 may be disposed to overlap the upper surface of the battery cell 2 in the up-down direction.

The temperature measurement unit 11 receives electromagnetic waves W having a unique wavelength according to the heat energy emitted from at least one battery cell 2, and measures the temperature based on this. In an embodiment, the electromagnetic waves W received by the temperature measurement unit 11 may be infrared.

The temperature measurement unit 11 guides the path of the electromagnetic waves W using a light guide plate 114 in the process of receiving the electromagnetic waves W. However, the electromagnetic waves W incident on the light guide plate 114 are partially guided by a pre-designed path, and the rest is reflected in a different direction by deviating from the pre-designed path.

The image sensor 12 detects the electromagnetic waves W reflected from a plurality of light guide plates 114 and outputs temperature spectrum information of one surface of the battery cell 2 based on this.

The image sensor 12 overlaps each of at least a partial region with respect to the plurality of light guide plates 114 in any one direction. Therefore, the electromagnetic waves W reflected from the plurality of light guide plates 114 may be received by one image sensor 12.

Accordingly, the temperature information throughput for the plurality of light guide plates 114 may be further reduced, and the possibility of an error in the measurement result may also be reduced. As a result, the stability of the operation of the entire battery cell 2 may be further improved.

The image sensor 12 may be disposed in all directions, up, down, left, right, front, and rear, with respect to a plurality of light guide plates 114. Therefore, the image sensor 12 may more easily receive electromagnetic waves W reflected from a plurality of light guide plates 114 formed in various arrangements. Therefore, the applicability and utilization of the abnormal temperature detection system 1 may be further improved.

In addition, the image sensor 12 may detect an abnormal temperature for the battery cell 2 even with an area smaller than the area of the light guide plate 114. Therefore, the overall structure of the abnormal temperature detection system 1 may be further simplified. Furthermore, manufacturing costs and processes may be further reduced.

The temperature spectrum information output from the image sensor 12 is transmitted to the calculation unit 14.

When the temperature of one surface of the battery cell 2 is out of a preset temperature range, the calculation unit 14 determines that an abnormal temperature is detected in the battery cell 2.

In an embodiment, when the temperature of one surface of the battery cell 2 is 65° C. or higher, the calculation unit 14 may determine that an abnormal temperature is detected in the battery cell 2.

In addition, when an abnormal temperature is detected, the calculation unit 14 may estimate the location where the abnormal temperature occurs based on the temperature spectrum information. For example, when an abnormal temperature is detected, the calculation unit 14 may estimate the location of the light guide plate 114 in which the abnormal temperature is detected among the plurality of light guide plates 114.

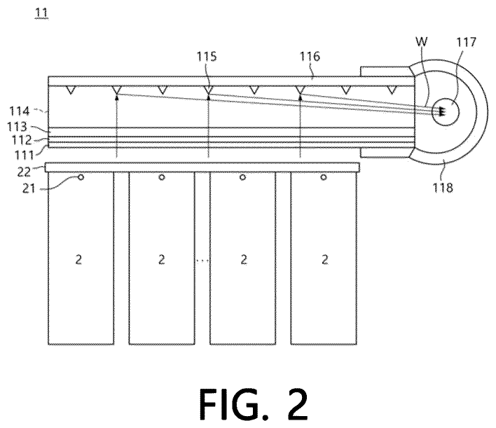

Hereinafter, the temperature measurement unit 11 will be described in more detail with reference to FIGS. 2 to 4.

As described above, the temperature measurement unit 11 overlaps at least a partial region of one surface of the battery cell 2 in one direction. Accordingly, the electromagnetic waves W radiated from the battery cell 2 may be incident on the temperature measurement unit 11.

In the illustrated embodiment, the battery cell 2 may include an amplification light source 21 for amplifying electromagnetic waves W having a unique wavelength according to the temperature generated by radiation and making incident on the light guide plate 114. The amplification light source 21 may emit infrared light having a wavelength of an infrared region.

In addition, the battery cell 2 may include a layer 22 formed by applying a Zion pigment to one surface facing the temperature measurement unit 11. The Zion pigment may be a pigment that changes color depending on temperature.

The layer 22 may be formed by applying a Zion pigment that discolors to a predetermined color when the battery cell 2 exceeds a preset reference temperature.

In the illustrated embodiment, the temperature measurement unit 11 includes a protective film 111, a prism sheet 112, a diffusion sheet 113, a light guide plate 114, an optical pattern part 115, a reflective member 116, a light-receiving sensor 117, and a light-receiving cover 118.

The protective film 111 may serve to protect the light collecting part of the light guide plate 114 and the like. In addition, the protective film 111 may serve to prevent damage caused by contact between the battery cell 2 and the temperature measurement unit 11.

In an embodiment, the protective film 111 may be formed of an acrylic transparent resin. However, the protective film 111 is not limited to the above materials and may be formed of various materials capable of protecting the light collecting part.

The prism sheet 112 is a sheet that increases light efficiency and can convert the front light incident from the battery cell 2 into a side light.

The diffusion sheet 113 may scatter light incident on the light guide plate 114 again so that the light may be evenly incident.

When the electromagnetic waves W radiated from at least one battery cell 2 is incident, the light guide plate 114 may emit light by changing the path of the incident electromagnetic waves W to the other side. For example, the light guide plate 114 may change the path of the electromagnetic waves W incident in a substantially vertical direction from the battery cell 2. In an embodiment, the electromagnetic waves W incident on the light guide plate 114 may be infrared.

It is assumed that a plurality of light guide plates 114 according to an exemplary embodiment of the present disclosure are provided. Each of the plurality of light guide plates 114 overlaps at least a partial region of one surface of the battery cell 2 in one direction. However, the light guide plate 114 is disposed so as not to overlap a connector provided in the battery cell 2 in the one direction. A detailed description thereof will be described later.

In an embodiment, the light guide plate 114 may be formed of a light transmitting material having a constant refractive index.

The light guide plate 114 may be coupled to a Fresnel lens 114a.

The Fresnel lens 114a is one of the condensing lenses and serves to collect light like a convex lens. The Fresnel lens 114a may concentrate the electromagnetic waves W emitted from the battery cell 2 to one place. That is, the electromagnetic waves W concentrated on the light guide plate 114 may be incident.

In an embodiment, the Fresnel lens 114a may be formed to have a length and a width larger than that of the light guide plate 114. In the above embodiment, even when the light guide plate 114 is formed to have a smaller area than the upper surface of the battery cell 2, the Fresnel lens 114a covers the upper surface of the battery cell 2 to concentrate the electromagnetic waves W emitted from the battery cell 2, so that the concentrated electromagnetic waves W may be incident on the light guide plate 114.

In addition, the reflective member 116 is coupled to one side of the light guide plate 114.

By reflecting the electromagnetic waves W incident on the light guide plate 114, the reflective member 116 prevents the electromagnetic waves W incident on the light guide plate 114 from being lost by deviating from the pre-designed path.

The reflective member 116 may be formed in a film form, but is not limited thereto.

In addition, the reflective member 116 may include an optical pattern part 115.

The optical pattern part 115 may diffuse or reflect electromagnetic waves W incident from the battery cell 2 so that light is not concentrated. A pattern for performing light reflection, light diffusion, light scattering, or light blocking may be formed on the optical pattern part 115.

The light-receiving sensor 117 receives the condensed electromagnetic waves W. The light guide plate 114 guides the electromagnetic waves W incident on the light guide plate 114 toward the light-receiving sensor 117.

In the illustrated embodiment, the light-receiving sensor 117 is disposed adjacent to the side surface of the light guide plate 114.

In an embodiment, the light-receiving sensor 117 may be an infrared sensor. The infrared sensor may refer to a sensor that detects a physical quantity such as temperature using infrared rays and converts it into an amount of electricity capable of signal processing.

The side surface of the light-receiving sensor 117 may be supported by a light-receiving sensor support part 117a.

The light-receiving sensor 117 may be provided in plural. The plurality of light-receiving sensors 117 may be disposed adjacent to one surface of the light guide plate 114 at a predetermined interval. This is to sufficiently receive the electromagnetic waves W when the electromagnetic waves W emitted from the plurality of battery cells 2 is condensed by changing the path to one side of the light guide plate 114.

In the illustrated embodiment, the light-receiving sensor 117 is disposed to be surrounded by the light-receiving cover 118.

The light-receiving cover 118 is located radially outside the light-receiving sensor 117 to prevent wavelengths other than the electromagnetic waves W passing through the light guide plate 114 from being incident on the light-receiving sensor 117.

In the illustrated embodiment, the light-receiving cover 118 is formed in a dome structure surrounding the light-receiving sensor 117. However, the light-receiving cover 118 is not limited to the illustrated structure, but can be formed in various structures capable of shielding electromagnetic waves W incident through paths other than those passing through the light guide plate 114.

In an embodiment, the light-receiving cover 118 may be formed of a material that shields the electromagnetic waves W.

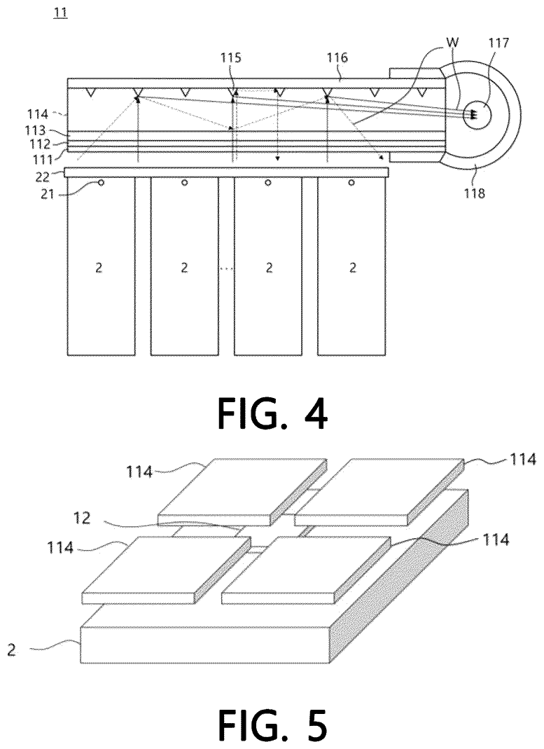

FIG. 4 illustrates a path of electromagnetic waves W radiated from the battery cell 2 and incident on the temperature measurement unit 11.

Much of the electromagnetic waves W incident on the light guide plate 114 is guided laterally and proceeds toward the light-receiving sensor 117 (see solid arrow).

However, a part of the electromagnetic waves W incident on the light guide plate 114 is reflected by the optical pattern part 115 or the reflective member 116 and then proceeds toward the incident surface (see dotted arrow). That is, a part of the electromagnetic waves W is not guided to the light-receiving sensor 117 but proceeds in a different direction and is lost.

As described above, since the image sensor 12 overlaps the light guide plate 114 in one direction, it can receive the lost electromagnetic waves W and output temperature spectrum information based on this.

Hereinafter, the image sensor 12 according to an exemplary embodiment of the present disclosure will be described in more detail with reference to FIGS. 5 to 9.

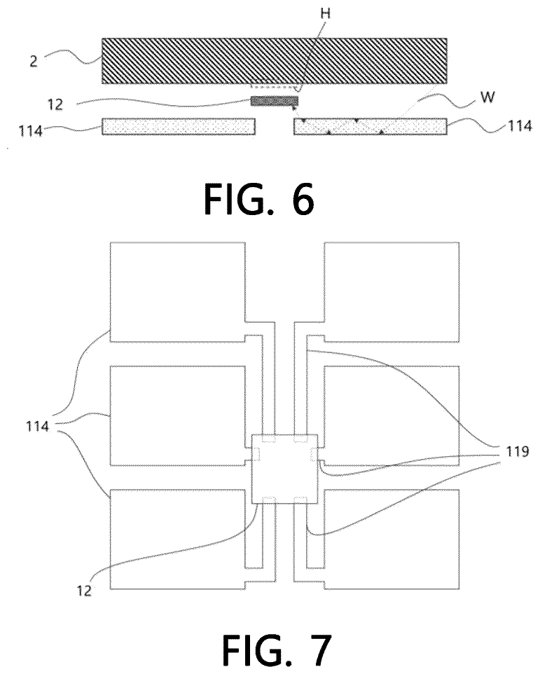

In the embodiment shown in FIGS. 5 to 6, a plurality of light guide plates 114 overlap at least a partial region of one surface of the battery cell 2 in the up-down direction, respectively. However, two light guide plates 114 adjacent to each other are arranged to be spaced apart from each other at a predetermined interval.

The plurality of light guide plates 114 are arranged in a matrix structure with a plurality of rows arranged side by side in left-right or front-rear direction. However, the arrangement structure of the plurality of light guide plates 114 is not limited to the illustrated structure and they may be formed in various structures.

In addition, the plurality of light guide plates 114 are disposed so as not to overlap a high-temperature section H in the up-down direction, respectively. Since the high-temperature section H is equipped with a cable connection part (not shown) and a connector (not shown) of the battery cell 2 to maintain a high-temperature state at all times, it is preferable to exclude it from temperature monitoring. To this end, a plurality of light guide plates 114 are provided, and two adjacent light guide plates 114 are spaced apart from each other at regular intervals so that each light guide plate 114 does not overlap with the high-temperature section H.

In the embodiment shown in FIG. 7, a withdrawal portion 119 is formed on one side of the light guide plate 114.

The withdrawal portion 119 is formed on one side of at least one of the plurality of light guide plates 114 and extends toward the image sensor 12. In addition, one end of the withdrawal portion 119 overlaps the image sensor 12 in one direction.

In an embodiment, a coating layer made of a material shielding electromagnetic waves W may be formed on an outer circumferential surface of the withdrawal portion 119.

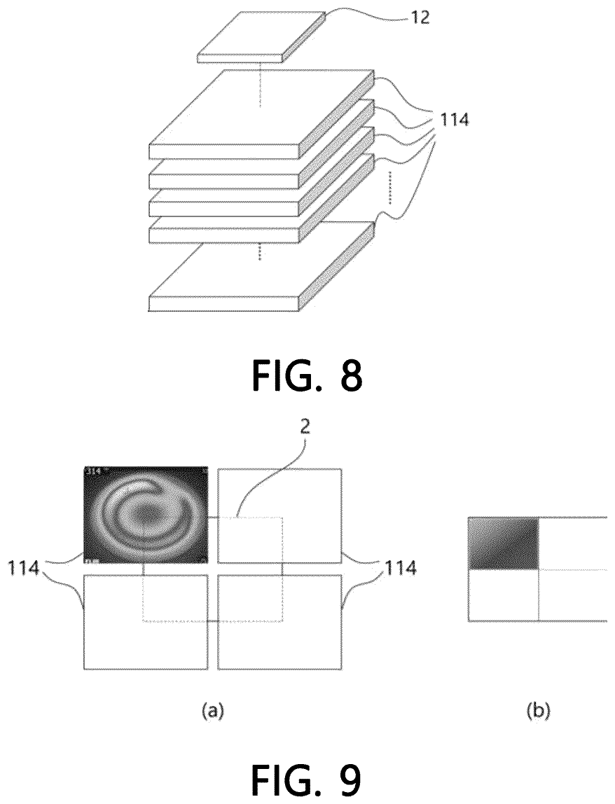

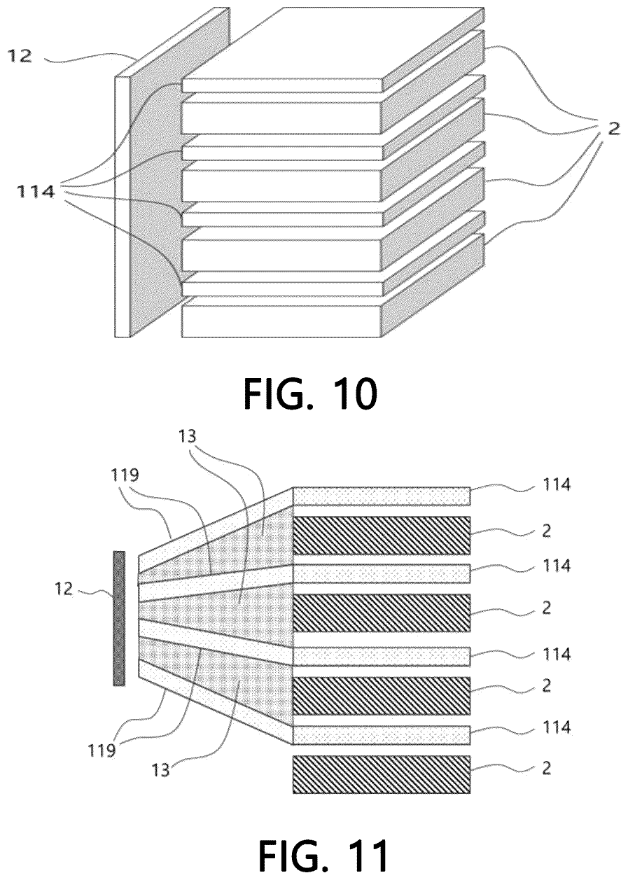

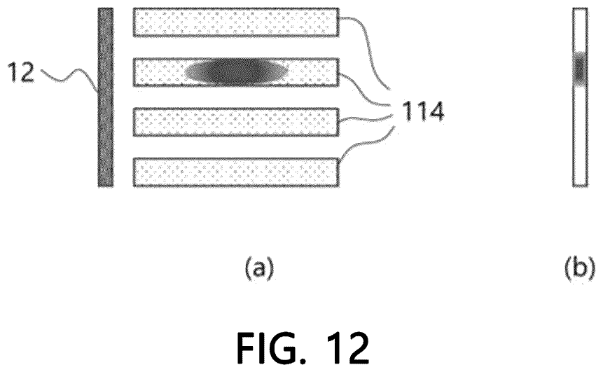

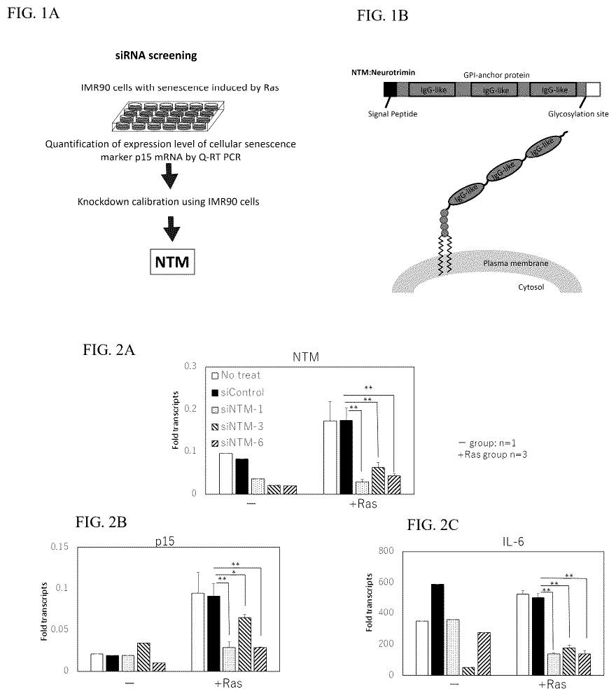

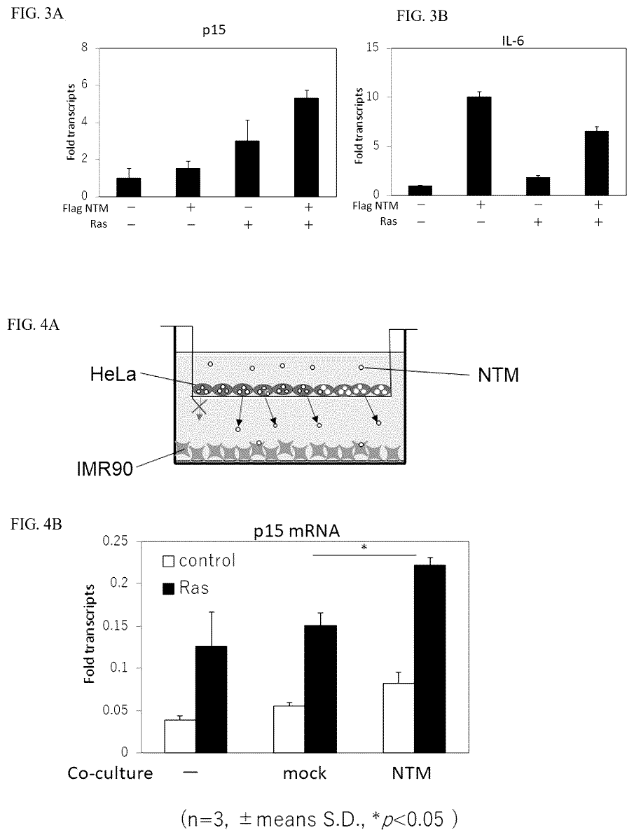

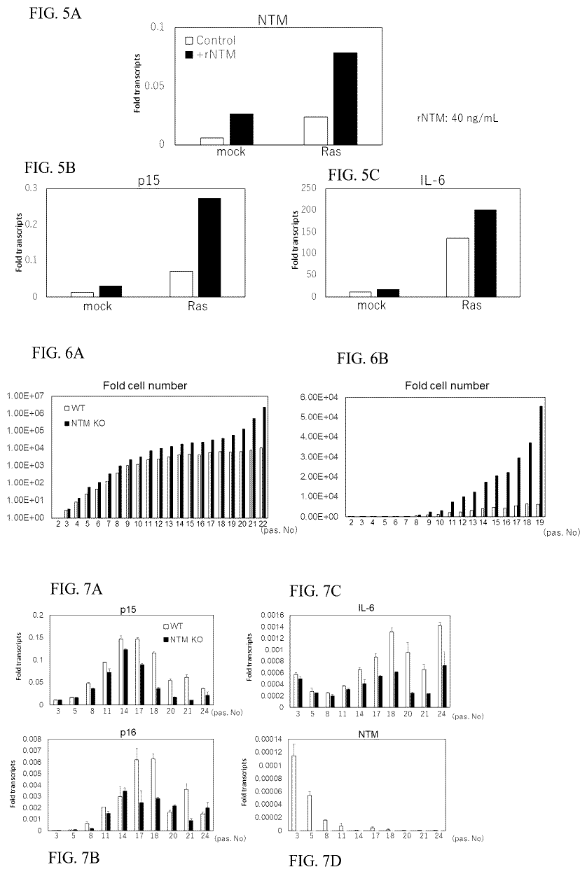

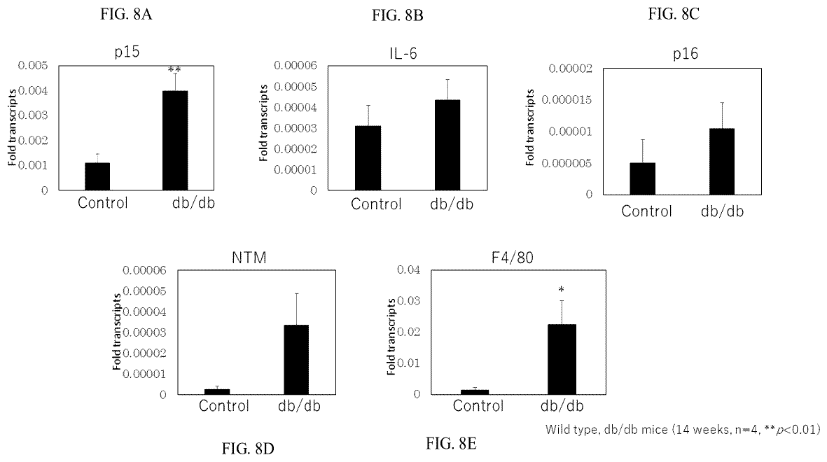

In the embodiment shown in FIG. 8, a plurality of light guide plates 114 are arranged side by side in the up-down direction. In this case, at least a partial region of the light guide plate 114 overlaps the image sensor 12 in the up-down direction. That is, the image sensor 12 may receive electromagnetic waves W reflected from each of the plurality of light guide plates 114 in the up-down direction. Subsequent processes are omitted because they have been described above.

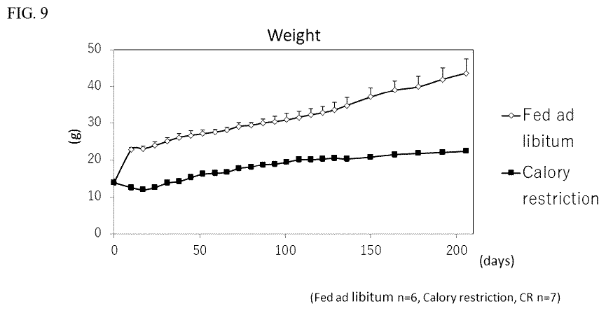

Hereinafter, an abnormal temperature detection process when an abnormal temperature occurs in the battery cell 2 will be described with reference to FIG. 9.

FIG. 9(a) and FIG. 9(b) respectively illustrate the temperature distribution of the light guide plate 114 and the temperature spectrum information output from the image sensor 12 when an abnormal temperature occurs in the battery cell 2.

As described above, the image sensor 12 overlaps the plurality of light guide plates 114 and the battery cell 2 in one direction.

When an electromagnetic wave W corresponding to an abnormal temperature is incident on any one light guide plate 114 of the plurality of light guide plates 114, for example, the light guide plate 114 at the upper left in the illustrated embodiment (see FIG. 9(a)), the image sensor 12 outputs a temperature spectrum in which the abnormal temperature is displayed in a region where the light guide plate 114 and the image sensor 12 overlap (see FIG. 9(b)).

The manager can detect the occurrence of abnormal temperature in the battery cell 2 through the output temperature spectrum and estimate the location of the occurrence.

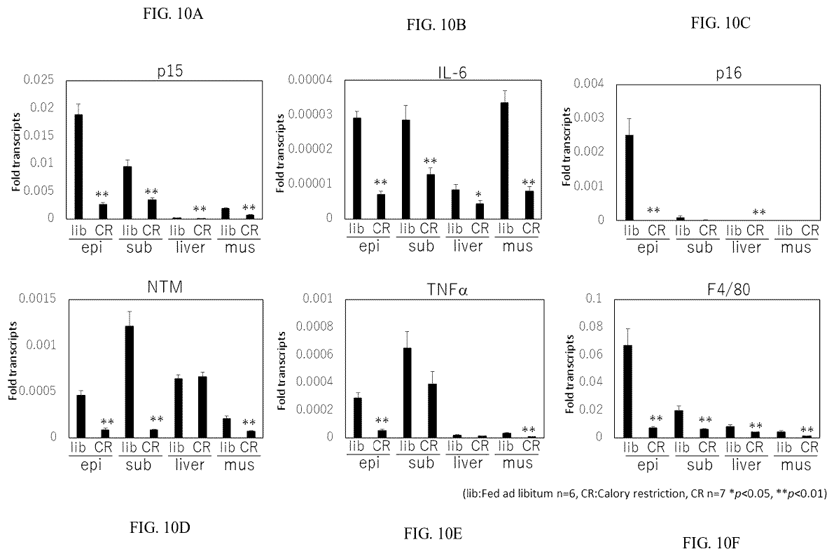

As described above, the abnormal temperature detection system 1 according to an exemplary embodiment of the present disclosure has been described. Hereinafter, an abnormal temperature detection system 1 according to another exemplary embodiment of the present disclosure will be described with reference to FIGS. 10 to 12.

The abnormal temperature detection system 1 according to the present embodiment has a similar structure and function compared to the abnormal temperature detection system 1 according to the above-described embodiment. However, the abnormal temperature detection system 1 according to the present embodiment differs from the abnormal temperature detection system 1 according to the above-described embodiment in that the image sensor 12 overlaps the light guide plate 114 in a direction different from the arrangement direction of the battery cell 2 and the light guide plate 114. Hereinafter, a description overlapping the abnormal temperature detection system 1 according to the above-described embodiment will be omitted, and the abnormal temperature detection system 1 according to the present embodiment will be described, focusing on the difference.

The abnormal temperature detection system 1 according to the present embodiment includes a temperature measurement unit 11, an image sensor 12, a filler 13, and a calculation unit 14.

Each of the temperature measurement unit 11 and the calculation unit 14 according to the present embodiment has the same structure and function as the temperature measurement unit 11 and the calculation unit 14 according to the above-described embodiment. Accordingly, the description thereof is omitted.

The image sensor 12 according to the present embodiment overlaps the light guide plate 114 in a direction different from the arrangement direction of the battery cell 2 and the light guide plate 114. In the illustrated embodiment, the battery cell 2 and the light guide plate 114 are arranged side by side in the up-down direction, whereas the image sensor 12 is arranged to overlap the light guide plate 114 in the left-right direction.

However, the image sensor 12 is the same as the image sensor 12 according to the above-described embodiment in that it overlaps with each of the plurality of light guide plates 114 in one direction.

A plurality of light guide plates 114 according to the present embodiment are provided, and are arranged in a direction parallel to the arrangement direction of the battery cells 2. That is, the plurality of light guide plates 114 overlap in a direction parallel to the arrangement direction of the battery cells 2. In this case, any one of the plurality of battery cells 2 is disposed between two light guide plates 114 adjacent to each other.

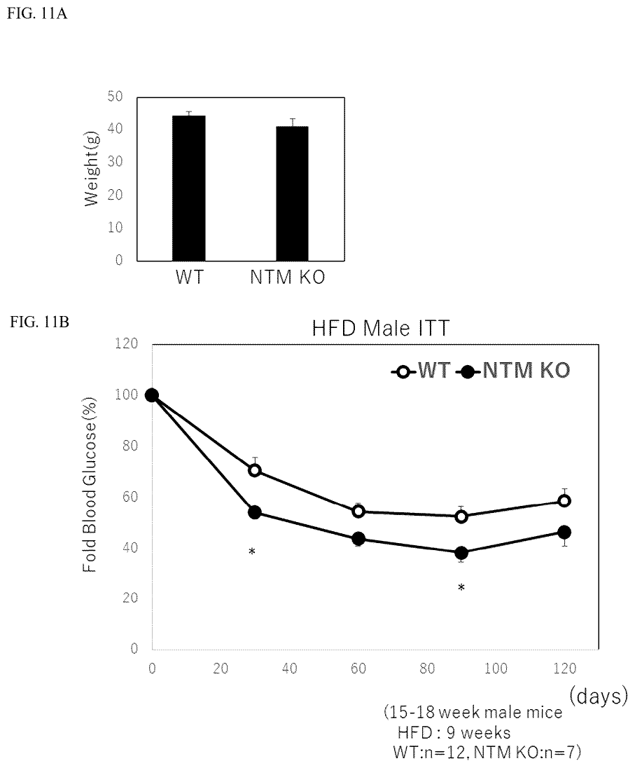

In an embodiment, the filler 13 may be disposed between two light guide plates 114 adjacent to each other (see FIG. 11).

The filler 13 allows two light guide plates 114 adjacent to each other to be spaced apart from each other. This is to improve the resolution capability, as the light guide plate 114, which is generally formed in a thin thickness, is highly likely to be output to a low pixel when stacked in multiple layers. That is, this is to more easily determine the location of the occurrence of the abnormal temperature when the abnormal temperature is detected.

In the embodiment shown in FIG. 11, a withdrawal portion 119 is formed on one side of each light guide plate 114 toward the image sensor 12. In the above embodiment, the filler 13 is disposed between two adjacent withdrawal portions 119.

In an embodiment, the filler 13 may be formed of an acrylic material.

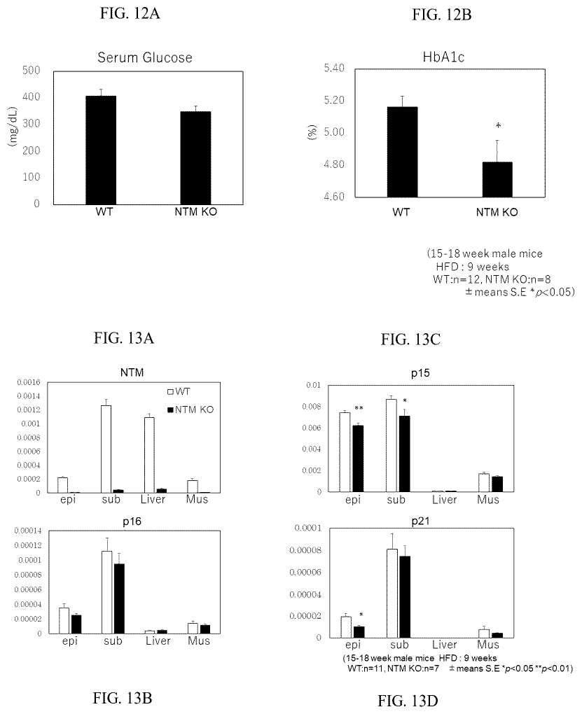

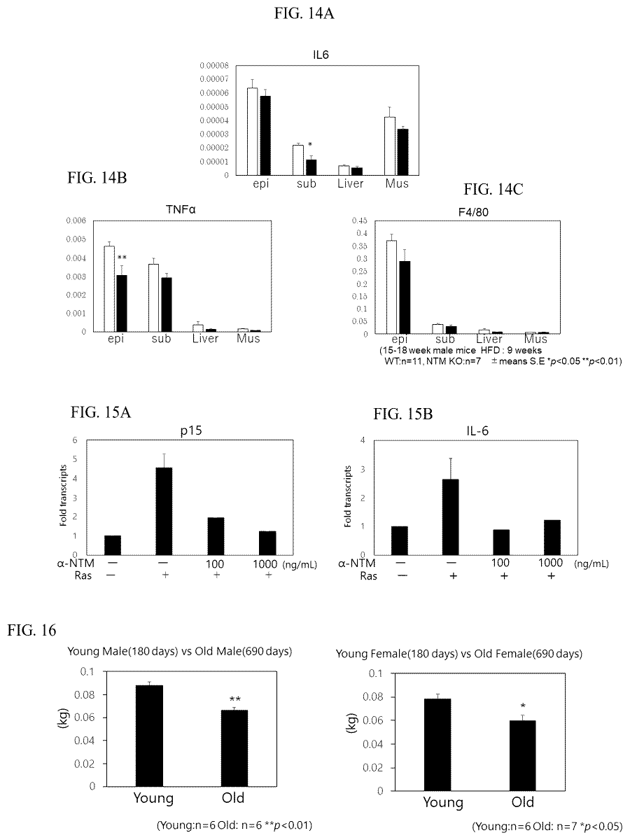

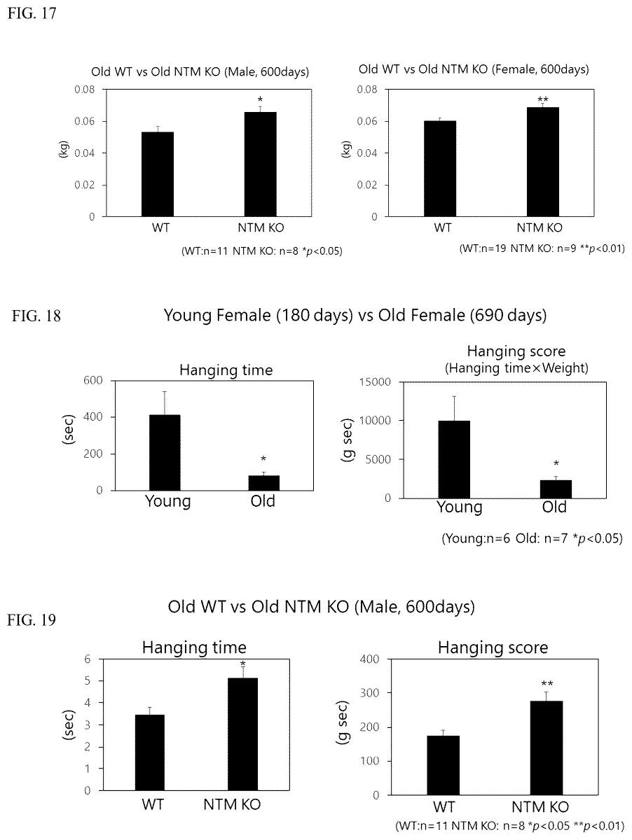

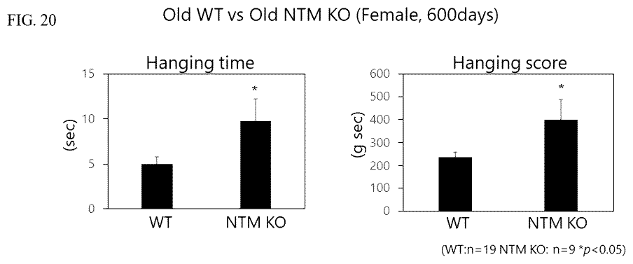

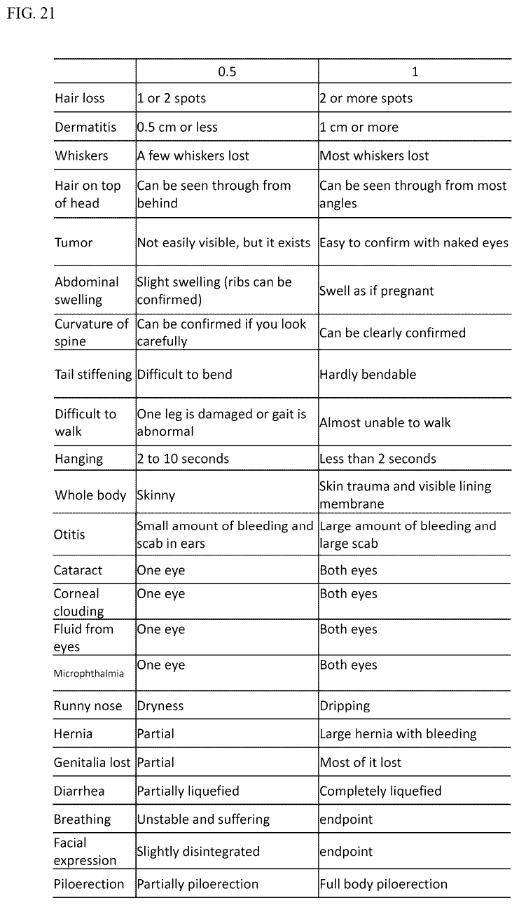

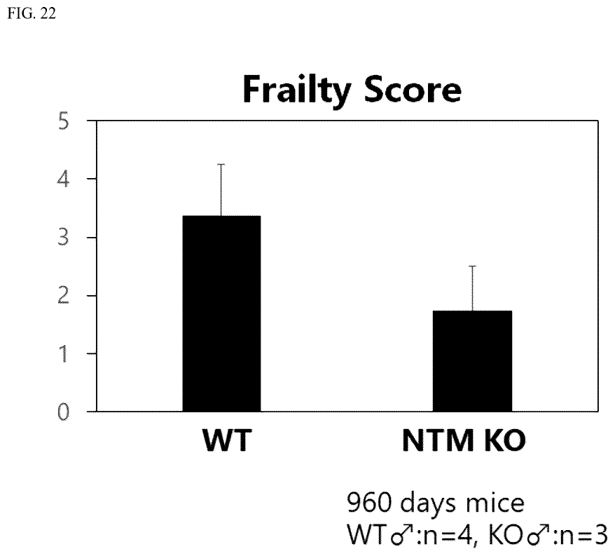

Hereinafter, an abnormal temperature detection process when an abnormal temperature occurs in the battery cell 2 will be described with reference to FIG. 12.

FIG. 12(a) and FIG. 12(b) respectively illustrate the temperature distribution of the light guide plate 114 and the temperature spectrum information output from the image sensor 12 when an abnormal temperature occurs in the battery cell 2.

As described above, the image sensor 12 overlaps a plurality of light guide plates 114 in a direction different from the arrangement direction of the light guide plates 114.

When an electromagnetic wave W corresponding to an abnormal temperature is incident on any one light guide plate 114 of the plurality of light guide plates 114, for example, the second light guide plate 114 from the top in the illustrated embodiment (see FIG. 12(a)), the image sensor 12 outputs a temperature spectrum in which the abnormal temperature is displayed in a region where the light guide plate 114 and the image sensor 12 overlap (see FIG. 12(b)).

The manager can detect the occurrence of abnormal temperature in the battery cell 2 through the output temperature spectrum and estimate the location of the occurrence.

Although the present disclosure has been described above with reference to preferred exemplary embodiments thereof, the present disclosure is not limited to the configurations of the above-described embodiments.

In addition, the present disclosure may be variously modified and changed without departing from the idea and scope of the present disclosure described in the following claims by those skilled in the art to which the present disclosure pertains.

Furthermore, the embodiments may be configured by selectively combining all or some of the embodiments so that various modifications may be made thereto.

| | |
|---|---|
| 1: abnormal temperature detection system | 11: temperature |
| | measurement unit |
| 111: protective film | 112: prism sheet |
| 113: diffusion sheet | 114: light guide plate |
| 114a: Fresnel lens | 115: optical pattern part |
| 116: reflective member | 117: light-receiving sensor |
| 117a: light-receiving sensor support part | 118: light-receiving cover |
| 119: withdrawal portion | 12: image sensor |
| 13: filler | 14: calculation unit |
| 2: battery cell | 21: amplification light source |
| 22: layer | W: electromagnetic wave |
| H: high-temperature section | |

1. An abnormal temperature detection system, comprising:
a plurality of light guide plates which overlap at least a partial region of one surface of a battery cell in one direction, are struck by electromagnetic waves radiated from the battery cell, and change the path of the electromagnetic waves;
an image sensor which overlaps at least a partial region of each of the plurality of light guide plates in the one direction, detects the electromagnetic waves reflected from the light guide plates, and outputs temperature spectrum information for the one surface of the battery cell on the basis of the detected electromagnetic waves; and
a calculation unit which determines that an abnormal temperature has been detected in the battery cell if the temperature of the one surface of the battery cell is outside a preset temperature range.

2. The abnormal temperature detection system of claim 1, wherein the electromagnetic waves are infrared.

3. The abnormal temperature detection system of claim 1, wherein the plurality of light guide plates are arranged side by side in a different direction crossing the one direction.

4. The abnormal temperature detection system of claim 3, wherein a withdrawal portion whose one end overlaps the image sensor in the one direction is formed on one side of at least one of the plurality of light guide plates.

5. The abnormal temperature detection system of claim 4, wherein a coating layer made of a material that shields electromagnetic waves is formed on the outer circumferential surface of the withdrawal portion.

6. The abnormal temperature detection system of claim 3, wherein the plurality of light guide plates are arranged in a matrix structure with a plurality of rows arranged side by side in the different direction.

7. The abnormal temperature detection system of claim 1, wherein the plurality of light guide plates are arranged side by side in the one direction.

8. The abnormal temperature detection system of claim 1, wherein each of the plurality of light guide plates is disposed so as not to overlap a connector provided in the battery cell in the one direction.

9. The abnormal temperature detection system of claim 1, wherein when an abnormal temperature is detected in the battery cell, the calculation unit estimates a location of the occurrence of the abnormal temperature based on the temperature spectrum information.

10. An abnormal temperature detection system, comprising:
a plurality of light guide plates which overlap at least a partial region of one surface of a battery cell in one direction, are struck by electromagnetic waves radiated from the battery cell, and change the path of the electromagnetic waves;
an image sensor which overlaps at least a partial region of each of the plurality of light guide plates in a direction crossing the one direction, detects the electromagnetic waves reflected from the light guide plates, and outputs temperature spectrum information for the one surface of the battery cell on the basis of the detected electromagnetic waves; and
a calculation unit which determines that an abnormal temperature has been detected in the battery cell if the temperature of the one surface of the battery cell is outside a preset temperature range,
wherein the plurality of light guide plates are arranged side by side in the one direction.

11. The abnormal temperature detection system of claim 10, wherein the electromagnetic waves are infrared.

12. The abnormal temperature detection system of claim 10, wherein two light guide plates adjacent to each other of the plurality of light guide plates are spaced apart from each other by placing a filler therebetween.

13. The abnormal temperature detection system of claim 10, wherein the plurality of light guide plates overlap a plurality of said battery cells in the one direction, and any one of the plurality of battery cells is disposed between said two adjacent light guide plates.

14. The abnormal temperature detection system of claim 10, wherein each of the plurality of light guide plates is disposed so as not to overlap a connector provided in the battery cell in the one direction.

15. The abnormal temperature detection system of claim 10, wherein when an abnormal temperature is detected in the battery cell, the calculation unit estimates a location of the occurrence of the abnormal temperature based on the temperature spectrum information.
